(19) United States
(12) Patent Application Publication
(10) Pub. No.: US 2006/0139220 A1
(43) Pub. Date: Jun. 29, 2006

(54) Electronic apparatus and communication control method

(75) Inventors: Toshiyuki Hirota, Hino-shi (JP); Koichi Kaji, Hidaka-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/315,338

(22) Filed: Dec. 23, 2005

(30) Foreign Application Priority Data
Dec. 28, 2004 (JP) 2004-380499

(51) Int. Cl. H01Q 1/24

(52) U.S. Cl. 343/702

(57) ABSTRACT

An electronic apparatus comprises antennas, a first radio communication unit which performs radio communication by a first communication system having an antenna switching function in response to a reception state of electronic waves when the first communication unit is connected to any one of the antennas, a second communication unit which performs radio communication by a second communication system different from the first system when the second communication unit is connected to any one of the antennas, a setting unit which sets priorities of connection to the antennas in the first and the second communication unit, and a connection unit which connects any one of the antennas to a radio communication unit high in priority and connects the antennas not connected to the communication unit high in priority to a radio communication unit low in priority on the basis of the priorities which is set by the setting unit.

### CROSS-REFERENCE TO RELATED APPLICATIONS

This application is based upon and claims the benefit of priority from prior Japanese Patent Application No. 2004-380499, filed Dec. 28, 2004, the entire contents of which are incorporated herein by reference.

### BACKGROUND

1. Field

The present invention relates to an electronic apparatus, such as a notebook-sized personal computer (hereinafter, referred to as notebook PC), having a wireless communication function and its communication control method.

2. Description of the Related Art

Conventionally, some electronic apparatus, such as a notebook PC, having a communication function is equipped with a wireless communication function by a plurality of communication systems. The plurality of wireless communication systems mean, for example, a wireless LAN and Bluetooth (trademark).

Here, the wireless LAN sometimes uses a diversity function to switch between antennas to be used in accordance with a communication environment. In this case, the electronic apparatus firstly mounts a diversity antenna composed of two or more antennas for the wirelesses LAN in order to perform excellent communication though the wireless LAN. Then, the electronic apparatus switches between antennas to be used in accordance with the communication environment.

The electronic apparatus mounts one antenna for bluetooth in addition to the two antennas for the wireless LAN so as to perform communication by bluetooth. That is, the electronic apparatus needs three antennas in total so as to perform communication by the wireless LAN using the diversity function and bluetooth, respectively.

The electronic apparatus has many restrictions on mounting these three antennas thereon and it is hard to insolate those antennas. Therefore, a technique to reduce the number of antennas for such an electronic apparatus is presented by, for example, Jpn. Pat. Appln. KOKAI Publication No. 2002-73210.

In this technique, the electronic apparatus mounts one dedicated antenna for the wireless LAN and one shared antenna for both wireless LAN and bluetooth.

In accordance with the communication environment, such an electronic apparatus switches antennas for communicating through the wireless LAN with diversity function, between the dedicated antenna for the wireless LAN and the shared antenna. And when communicating through the bluetooth, the electronic apparatus uses the shared antenna as an antenna for the bluetooth.

However, in such a technique, the antenna allowed to be used in the case of communication by the bluetooth is fixed to one shared antenna among these two antennas.

Therefore, if the electronic apparatus intends to communicate by the wireless LAN and the bluetooth using the diversity function, the electronic apparatus cannot switch between antennas to be used for the wireless LAN in accordance with the communication environment while maintaining this communication.

### BRIEF DESCRIPTION OF THE SEVERAL VIEWS OF THE DRAWING

The accompanying drawings, which are incorporated in and constitute a part of the specification, illustrate embodiments of the invention, and together with the detailed description of the embodiments given below, serve to explain the principles of the invention.

FIG. 1 is a view showing an example of an appearance of a notebook PC according to a first embodiment of a present invention;

FIG. 2 is a block diagram showing a configuration example of an inner circuit of the notebook PC according to the first embodiment of the present invention;

FIG. 3 is a block diagram showing a configuration example of an inner circuit of a radio communication module 18 of the notebook PC in accordance with the first embodiment of the present invention;

FIG. 4 is a view showing an example of setting a screen regarding a communication processing by the notebook PC according to the first embodiment of the present invention;

FIG. 5 is a flowchart showing an example of a content of communication control processing performed by the notebook PC according to the first embodiment of the present invention;

FIG. 6 is a block diagram showing a configuration example of an inner circuit of the radio communication module 18 of a notebook PC according to a first modified example of the first embodiment of the invention;

FIG. 7 is a block diagram showing a configuration example of an inner circuit of a notebook PC according to a second modified example of the first embodiment;

FIG. 8 is a block diagram showing a configuration example of an inner circuit of the module 18 according to the second modified example of the first embodiment;

FIG. 9 is a block diagram showing a configuration of an inner circuit of the module 18 of a notebook PC according to a third modified example of the first embodiment of the present invention;

FIG. 10 is a flowchart showing a content of communication control processing executed by a notebook PC according to a third modified example of the first embodiment of the present invention;

FIG. 11 is a block diagram showing a configuration example of an inner circuit of a notebook PC according to a second embodiment of the present invention;

FIG. 12 is a block diagram showing a configuration of an inner circuit of the module 18 of the notebook PC according to the second embodiment of the present invention;

FIG. 13 is a view showing an example of a setting screen G2 regarding a communication control processing by the notebook PC according to the second embodiment of the present invention;

FIG. 14 is a flowchart showing a content of communication control processing executed by the notebook PC according to the second embodiment of the present invention;

FIG. 15 is a block diagram showing a configuration example of an inner circuit of a notebook PC according to a third embodiment of the present invention;

FIG. 16 is a block diagram showing a configuration example of inner circuits of modules 70 and 71.

FIG. 17 is a block diagram showing other configuration example of the inner circuit of the notebook PC according to the third embodiment of the present invention; and

FIG. 18 is a block diagram showing other configuration example of the inner circuits of the modules 70 and 71 of the notebook PC according to the third embodiment of the present invention.

### DETAILED DESCRIPTION

Hereinafter, an embodiment in which the present invention is adapted to a notebook PC will be described by referring to drawings.

### FIRST EMBODIMENT

At first, a first embodiment of the present invention will be described.

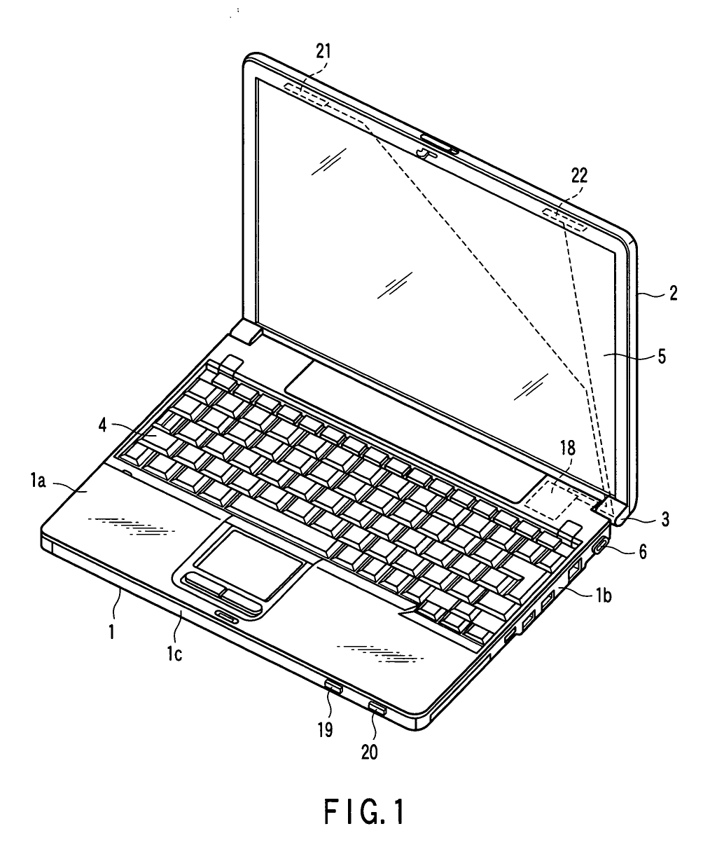

FIG. 1 is a view showing an example of an appearance of the notebook PC according to the first embodiment of the present invention.

As shown in FIG. 1, the notebook PC has a main body case 1, a display unit case 2 and hinge units 3. An upper face 1a of the main body case 1 is provided with a keyboard 4 to which a user performs input operations.

The display unit case 2 supports a periphery unit of a liquid crystal display (LCD) 5 being a display device so that the periphery unit is visible from inside. Thereby the display face of the LCD 5 becomes visible.

The hinge units 3 connect the main body case 1 to the display unit case 2. The hinge units 3 support the display unit case 2 rotatably between a closed state and an opened state with a rotation shaft (not shown) as a center. The closed state is a state in which the display unit case 2 covers the keyboard 4. The opened state is a state in which the keyboard 4 is exposed for allowing the user to use the keyboard 4.

A side face 1b of the main body case 1 is provided with a power switch 6. The power switch 6 is a device to instruct switching of system states (operation states) of the notebook PC between a state in which an operating system (OS) is actuated (hereinafter, referred to as actuation state) and a state in which the OS is terminated (hereinafter, referred to as shutdown state).

The main body case 1 houses a radio communication module 18. The display unit case 2 houses an antenna 21 and an antenna 22. The module 18 is connected to the antennas 21 and 22 through the hinge units 3.

A side face 1c of the main body case 1 is equipped with a LAN switch 19 and a bluetooth switch 20. These switches will be described later.

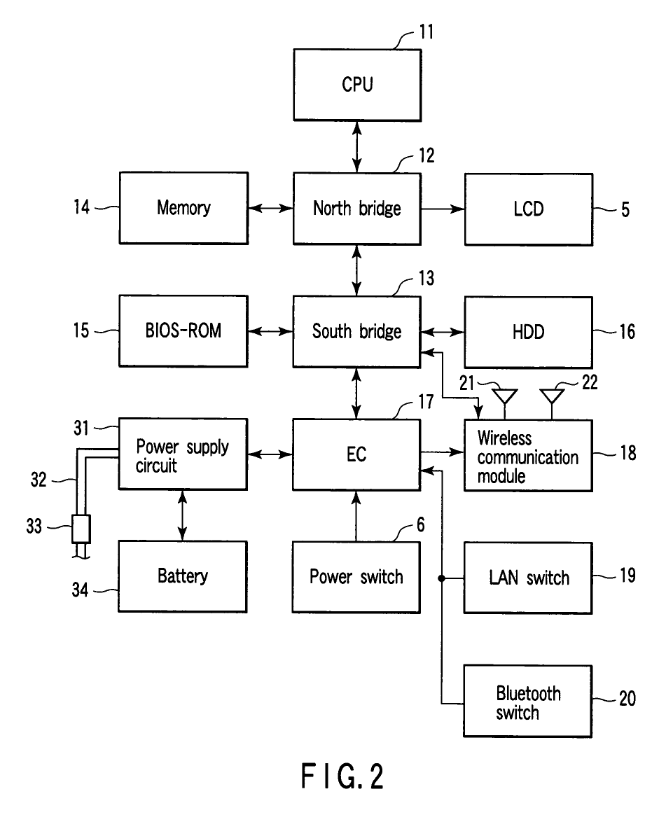

FIG. 2 is a block diagram showing a configuration example of an inner circuit of the notebook PC according to the first embodiment of the present invention.

FIG. 2 shows only the configuration of sections related to the present invention in the inner circuit of the notebook PC. The notebook PC is equipped with a CPU 11 to control the whole of the notebook PC.

The CPU 11 is connected to a north bridge 12 (hereinafter, referred to as the NB). The NB 12 is connected to a south bridge 13 (hereinafter, referred to as the SB).

The NB 12 is, for example, a bridge circuit for executing processing such as data and address conversions between the CPU 11 being a device connected to the NB 12. The SB 13 is a bridge circuit for executing data input/output processing, etc., among devices connected with one another through the SB 13.

The NB 12 is connected to a main memory 14 becoming a work area during the operations of the CPU 11. The NB 12 is connected to the LCD 5.

The SB 13 is connected to a BIOS-ROM 15. The BIOS-ROM 15 stores a program for controlling the basic input-output control and for managing the power-supplying state. The BIOS-ROM 15 stores a control processing program regarding processing of radio communication (hereinafter, referred to as communication control processing).

The SB 13 is connected to a hard disk drive (HDD) 16. The HDD 16 is a nonvolatile storage medium. The HDD 16 is a device capable of storing data even in a situation of no power is supplied to a power source of the notebook PC.

The HDD 16 stores the OS and the application program, etc. When the CPU 11 executes these programs, the programs are developed in an appropriate main memory 14.

A bus extended from the SB 13 is connected to an embedded controller (hereinafter, referred to as the EC) 17. The EC 17 is connected to a power switch 6. The EC 17 detects depressing of the power switch 6 to discriminate the current system state of the notebook PC.

The EC 17 shifts the system state between the actuation state and the shutdown state. The EC 17 shifts the system state of the notebook PC to the actuation state, for example, if the system state is the shutdown state at the time of detection of the depressing of the power switch 6. That is, the EC 17 operates to supply driving power to each device incorporated in the notebook PC.

The EC 17 is connected to the radio communication module 18 and a power supply circuit 31. The module 18 is connected to the antennas 21, 22, the SB 13 and the EC 17. The antennas 21, 22 perform transmission/reception of electric waves in a 2.4 GHz band. The module 18 is one to perform radio communication by a plurality of kinds of communication systems in the same frequency bands.

The plurality kinds of communication systems, here, mean a wireless LAN IEEE 802.11b using the electric waves in the 2.4 GHz band and the bluetooth using the electric waves in the 2.4 GHz band. Hereinafter, the wireless LAN IEEE 802.11b is referred to merely as the wireless LAN.

Here, the wireless LAN has a diversity function. The diversity function is a function to switch between a plurality of antennas to be used for the communication by the wireless LAN.

The power supply circuit 31 is connected to a power supply plug 33 via a power supply code 32. The power supply circuit 31 supplies necessary driving power to each device of the notebook PC, for example, to the CPU 11, etc.

The power supply circuit 31 is connected to a battery 34. The power supply circuit 31 obtains the driving power from the battery 34 in the case that external power cannot be obtained through the power supply plug 33 and supplies the driving power to each device.

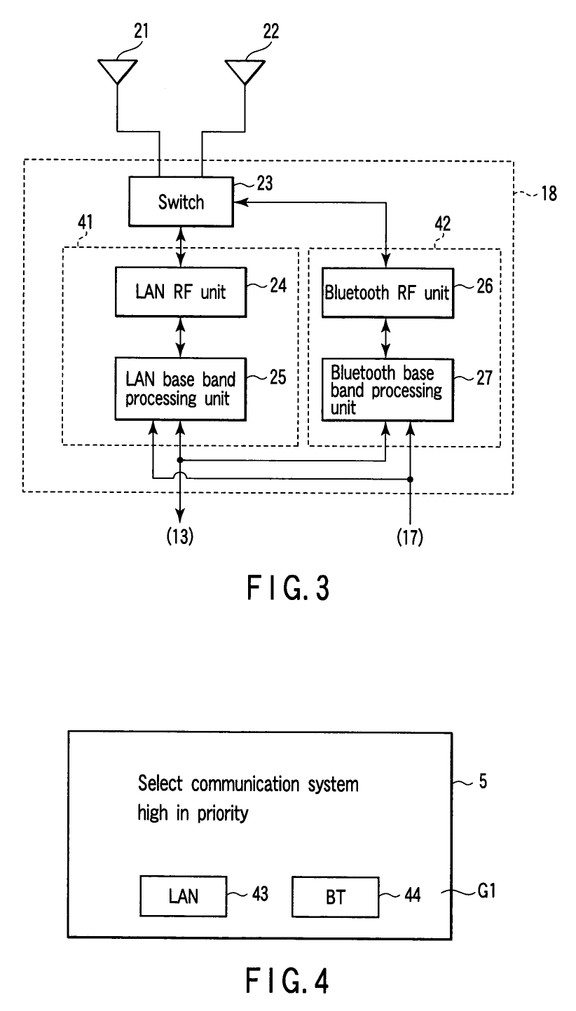

FIG. 3 is a block diagram showing a configuration example of an inner circuit of the radio communication module 18 of the notebook PC in accordance with the first embodiment of the present invention.

As shown in FIG. 3, the module 18 has a switch 23, an RF unit for LAN (hereinafter, referred to as LAN RF unit) 24, a baseband processing unit for LAN (hereinafter, referred to as LAN baseband processing unit) 25, an RF unit for bluetooth (hereinafter, referred to as bluetooth RF unit) 26 and a baseband processing unit for the bluetooth (hereinafter, referred to as bluetooth baseband processing unit) 27.

In the module 18, a LAN communication circuit 41 and a bluetooth communication circuit 42 are mounted on the same substrate. The LAN communication circuit 41 has the LAN RF unit 24 and the LAN baseband processing unit 25. The bluetooth communication circuit 42 has the bluetooth RF unit 26 and the bluetooth baseband processing unit 27.

The LAN RF unit 24 is connected to the LAN baseband processing unit 25. The bluetooth baseband processing unit 25 is connected to the EC 17 and the SB 13. The bluetooth RF unit 26 is connected to the bluetooth baseband unit 27. The bluetooth baseband unit 27 is connected to the EC 17 and the SB 13.

LAN RF unit 24 and the LAN baseband processing unit 25 are devices respectively having functions of performing communication through the wireless LAN. The bluetooth RF unit 26 and the bluetooth baseband processing unit 27 are devices respectively having functions of performing the communication through the bluetooth.

The EC 17 (cf. FIG. 2) detects the case that the LAN switch 19 or the bluetooth switch 20 is depressed. When detecting the depressing of the LAN switch 19, the EC 17 discriminates the operation state of the LAN communication circuit 41 to shift the operation state thereof between an on-state and an off-state.

For example, if the operation state of the LAN communication circuit is the off-sate in the case of the detection of depressing of the LAN switch 19, the EC 17 shifts the operation state of the LAN communication circuit 41 to the on-state. The off-state in the operation state of the LAN communication circuit 41 means an off-state in an operation state of a communication function by the wireless LAN.

When detecting the depressing of the bluetooth switch 20, the EC 17 discriminates the operation state of the bluetooth communication circuit 42 to shift the operation state thereof between the on-state and the off-state. The operation state of the bluetooth communication circuit 42 indicates an operation state of a communication function by the bluetooth.

The switch 23 is connected to the antenna 21 and 22. The switch 23 varies connection relations among the antenna 21, the LAN RF unit 24 and the bluetooth RF unit 26 so that a high-frequency signal from the antenna 21 is output to either the LAN RF unit 24 or the bluetooth RF unit 26.

The switch 23 varies connection relations among the antenna 22, LAN RF unit 24 and the bluetooth RF unit 26 so that a high-frequency signal from the antenna 22 is output to either the LAN RF unit 24 or the bluetooth RF unit 26.

However, the switch 23 varies a connection relations among the antennas 21 and 22, the LAN RF unit 24 and the bluetooth RF unit 26 so that the high-frequency signal from the antenna 21 and the high-frequency signal from the antenna 22 are not correctively output to the LAN RF unit 24 or the bluetooth RF unit 26.

The switch 23 outputs the high-frequency signal for transmission, which is input from the LAN RF unit 24, to an antenna connected to the LAN RF unit 24 among the antennas 21 and 22. The switch 23 outputs the high-frequency signal for the transmission, which is input from the bluetooth RF unit 26, to an antenna connected to the bluetooth RF unit 26 among the antenna 21 and 22.

The LAN RF unit 24 downconverts the high-frequency signal, which is output from the switch 23, into a baseband signal. The LAN RF signal 24 converts the high-frequency signal, which is output from the LAN baseband processing unit 25, into the baseband signal.

The LAN baseband processing unit 25 converts the baseband signal, which is output from the LAN RF unit 24, into a digital signal possible to be processed by the CPU 11 of the notebook PC. The LAN baseband processing unit 25 outputs this converted digital signal to the SB 13.

The LAN baseband processing unit 25 D/A-converts the digital data sent from the SB 13 and outputs this converted analog signal to the LAN RF unit 24.

The bluetooth RF unit 26 in the module 18 downconverts the high-frequency signal, which is output from the switch 23, into the baseband signal. The bluetooth RF unit 26 converts the baseband signal, which is output from the bluetooth baseband processing unit 27, into a high-frequency signal.

The bluetooth baseband processing unit 27 converts the baseband signal, which is output from the bluetooth RF unit 26, into a digital signal possible to be processed by the CPU 11 of the notebook PC. The bluetooth baseband processing unit 27 outputs this converted digital signal to the SB 13.

The bluetooth baseband processing unit 27 converts to order form the digital data sent from the SB 13, and outputs this converted analog signal to the bluetooth RF unit 26.

Next, communication control processing by the notebook PC according to the first embodiment of the present invention will be described.

FIG. 4 is a view showing an example of setting a screen regarding the communication processing by the notebook PC according to the first embodiment of the present invention.

The screen shown in FIG. 4 is one to set a communication system with a higher priority of an antenna selection when communication by the module 18 is performed.

Here, the user's performance of a prescribed operation displays a setting screen G1 (cf. FIG. 4) onto the LCD 5, and the processing by the SB 13 in the case of the selection of a LAN icon 43 of the screen G1 will be described.

In this case, the SB 13 outputs information, showing that the communication system with a higher priority of an antenna selection is the wireless LAN and the communication system with a lower priority of the antenna selection is the bluetooth, to the BIOS-ROM 15. This information is stored in the BOIS-ROM 15.

The processing of the SB 13 in the case that the user operates the prescribed operation to the keyboard 4 to select a bluetooth icon 44 will be described.

In this case, the SB 13 outputs information, denoting that the communication system with the higher priority of the antenna selection is the bluetooth and the communication system with the lower priority of the antenna selection is the wireless LAN, to the BIOS-ROM 15. This information is stored in the BIOS-ROM 15.

The processing of the notebook PC, in the first embodiment of the present invention when the user sets, for example, the wireless LAN as the communication system with the higher priority of the antenna selection according to the screen G1, will be explained.

In this case, the notebook PC according to the first embodiment of the present invention switches the antenna for the wireless LAN in response to a surrounding communication environment in preference to the antenna selection while performing both communication by the wireless LAN and the bluetooth.

After this switching, this notebook PC uses an antenna not used now for the communication by the wireless LAN as an antenna for the bluetooth.

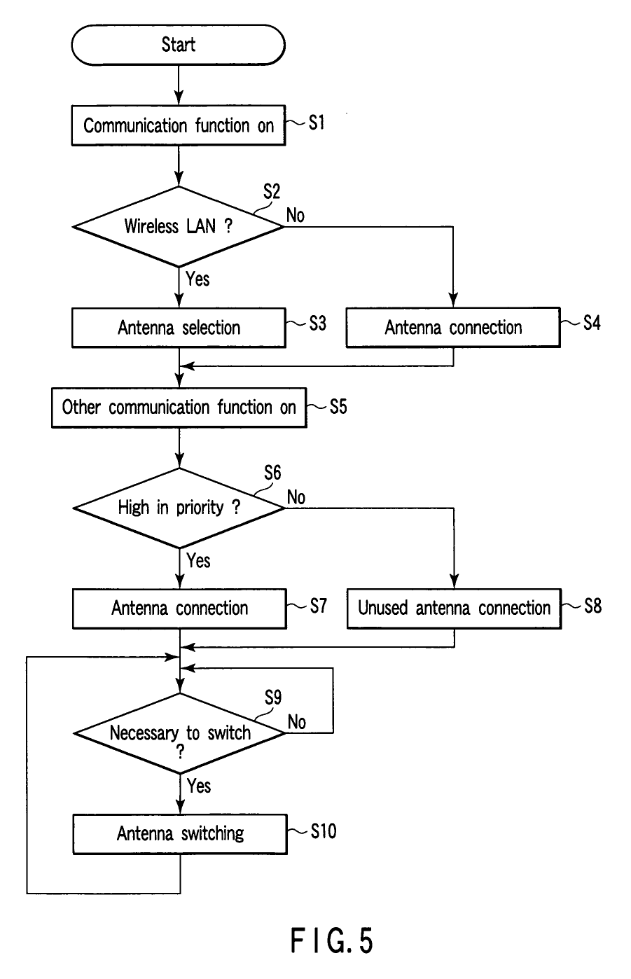

FIG. 5 is a flowchart showing an example of a content of communication control processing performed by the notebook PC according to the first embodiment of the present invention.

Here, it is assumed that the communication system, having a higher priority resulting from the antenna selection, is set to the wireless LAN. And it is assumed that the communication function by the wireless LAN and the operation state of the communication function by the bluetooth are both brought into off-states. And it is assumed that the antennas 21 and 22 are not connected to not only the LAN RF unit 24 but also the bluetooth RF unit 26.

Next, the operations of the SB 13, in the case that the operation state of the communication function by one kind of communication system is shifted from the off-state to the on-state by operating the switch to switch on/off of the operation state of the communication function by the user (step S1), will be described.

The switch to switch on/off of the operation state of the communication function is the LAN switch 19 or the bluetooth switch 20. In this case, the SB 13 selects one antenna to be used for the communication system in which the operation state of the communication function becomes the on-state.

More specifically, in the case that the switch operated as described above is the LAN switch 19 (YES, in step S2), the SB 13 outputs a control signal, which instructs the selection of an antenna to be connected to the LAN RF unit 24 in response to a surrounding communication environment, to the LAN baseband processing unit 25 of the module 18.

When inputting the control signal from the SB 13, the LAN baseband processing unit 25 respectively detects signal-to-noise ratios of high-frequency signals from the antennas 21 and 22. The LAN baseband processing unit 25 discriminates an antenna with a large signal-to-noise ratio of an output signal by comparing the detected signal-to-noise ratios.

The LAN baseband processing unit 25 controls the switch 23 so that an antenna discriminated as described above is connected to the LAN RF unit 24 (step S3). After this processing, the SB 13 stores information showing the kind of the antenna connected to the LAN RF unit 24 among the antenna 21 and 22 to the memory 14.

The SB 13 checks the information about the priorities of each communication system with the information about the communication system of the communication function the operation state of which is shifted to the on-state by the processing in the step S.

Checking like this, the SB 13 recognizes the information about the priorities set in the communication system of the communication function newly shifted to the on-state. The SB 13 stores this recognized information in the memory 14.

In Step S3, the LAN baseband processing unit 25 compares the high-frequency signals from the antennas 21 and 22 in terms of signal-to-noise ratio in order to select one of these antennas 21 and 22 for connection with the LAN RF unit 24.

However, it is not limited to the above-mentioned description; the LAN baseband processing unit 25 may have a function to measure error frequencies of the high-frequency signals from the antenna 21 and 22, respectively.

In this case, the LAN baseband processing unit 25 compares the measured error frequencies with each other and controls the switch 23 so that an antenna to be an origin of a signal with a low error frequency is connected to the LAN RF unit 24.

On the other hand, operations of the SB 13 in the case of that the switch operated by the user is not the LAN switch 19 but the bluetooth switch 20 (NO, in step S2), will be explained.

In this case, the SB 13 outputs a control signal, including information about the kind of antenna connected to the bluetooth RF unit 26 among the antennas 21 and 22, to the bluetooth baseband processing unit 27 of the module 18.

The bluetooth baseband processing unit 27 controls the switch 23 so that the antenna indicated by a signal input from the SB 13 is connected to the bluetooth RF unit 26.

When inputting a control signal from the SB 13, the switch 23 connects the antenna indicated by the information included in the input control signal among the antennas 21 and 22 to the bluetooth RF unit 26 (step S4).

After this processing, the SB 13 writes in the memory 14, the information indicating the kind of the antenna connected to the bluetooth RF unit 26 among the antennas 21 and 22.

Then, the SB 13 reads out the information about the priorities of each communication system stored in the BIOS-ROM 15. The SB 13 checks the information read out thereby with the information about the communication system of the communication function in which the operation state has been shifted to on-state by the processing in the step S1.

The SB 13 recognizes the information about the priority set in the communication system of the communication function in which the operation state is newly shifted to on-state to store it in the memory 14.

After processing in the step S3 or S4, the operations of the EC 17, in the case that the operation state of the communication function in the communication system, which is different from that in which the operation state is shifted to on-state by the processing in the foregoing step S1, is shifted from an off-state to an on-state resulting form switch operations by the user (step S5), will be described.

In this case, the EC 17 discriminates whether the switch operated by the user is the LAN switch 19 or the bluetooth switch 20.

The SB 13 recognizes the communication system corresponding to the kind of the switch discriminated by the EC 17. The SB 13 checks the information on these communication systems with the information on the priorities of the antenna selection for each communication system. The information about the priorities of the antenna selection is one stored in the BIOS-ROM 15.

With this checking, the SB 13 recognizes the priority set to the communication system of the communication function in which the operation state is shifted from off-state to on-state by the processing in the step S5. The SB 13 discriminates whether or not the recognized priority is higher than that set to the communication system of the communication function in which the operation state is shifted to on-state before processing in step S5 (step S6).

Operations of the SB 13, in the case that it is discriminated “YES” as the result from the step S6, namely, in the case that the SB 13 discriminates that the communication system of the communication function in which the operation state becomes the on-state by the processing in the step S5 is the wireless LAN, will be described.

In this case, the SB 13 outputs, a control signal to select the antenna connected to the LAN RF unit 24 among the antennas 21 and 22 in response to the surrounding communication environment, to the switch 23 of the module 18 via the LAN communication circuit 41.

When receiving the control signal from the SB 13, the switch 23 connects either the antenna 21 or 22 to the LAN RF unit 24 in response to the surrounding communication environment in the same manner as that of the step S3.

Then, the switch 23 varies the connection relations among the antennas 21, 22, the LAN RF unit 24 and the bluetooth RF unit 26 so that the antenna connected to the bluetooth RF unit 26 becomes an antenna different from that connected to the LAN RF unit 24 (step S7).

The processing, in the case that it is discriminated that the result of the processing in the step S6 is “NO”, in other words, in the case that it is discriminated that the communication system of the communication function in which the operation state becomes an on-state by the processing in the step S5 is the bluetooth, will be described.

In this case, the SB 13 reads out the information about the kind of antenna connected to the LAN RF unit 24.

The SB 13 outputs the control signal to instruct the use of an antenna, which is different from the antenna indicated by the information read out from the memory 14 and connected to the LAN RF unit 24 by the switch 23 among the antennas 21 and 22, for the communication by the bluetooth to the switch 23 through the LAN communication circuit 41.

After inputting this control signal, the switch 23 connects the antenna indicated by the information included in the control signal among the antennas 21 and 22 the bluetooth RF unit 26 (step S8).

After processing in the step S7 or S8, the LAN baseband processing unit 25 compares the signal-to-noise ratio of the high-frequency signal form the antenna 21 with the signal-to-noise ratio of the high-frequency signal from the antenna 22. The LAN baseband processing unit 25 repeats this processing at every lapse of prescribed time periods.

The communication environment surrounding the notebook PC is varied because the notebook PC is carried around or an obstacle is put around the notebook PC. As varying the communication environment around the notebook PC, the magnitude correlation between the signal-to-noise ratio of the high-frequency signal from the antenna 21 and the signal-to-noise ratio of the high-frequency signal from the antenna 22.

In such a case, it is required to switch an antenna by a diversity function of the wireless LAN to be a communication system with a higher priority is set therein.

The LAN baseband processing unit 25 discriminates whether or not antenna switching by the foregoing diversity function is required as the result of a comparison of the signal-to-noise ratio of the high-frequency signal (step S9).

Operations of the LAN baseband processing unit 25, in the case that the LAN baseband processing unit 25 discriminates that the antenna switching by the diversity is required (YES, in step S9), will be explained below.

In this case, the LAN baseband processing unit 25 outputs a control signal including instruction information to connect an antenna with a large signal-to-noise ratio of an output signal to the LAN baseband processing unit 25 among the antennas 21 and 22 to the LAN RF unit 24 to the switch 23 through the LAN RF unit 24.

The switch 23 inputs the control signal from the LAN baseband processing unit 25. Then, the switch 23 varies the connection relations among the antennas 21, 22, the LAN RF unit 24 and the bluetooth RF unit 26 so that the antenna with a large signal-to-noise ratio of an output signal to the LAN baseband processing unit 25 is newly connected to the LAN RF unit 24.

Then, the switch 23 varies the connection relations among the antennas 21, 22, the LAN RF unit 24 and the bluetooth RF unit 26 so that an antenna connected to the bluetooth RF unit 26 is switched to an antenna which is not the foregoing antenna which has been newly connected to the LAN RF unit 24 (step S10).

Operations, in the case that the communication function by the bluetooth corresponds to an function of switching antennas in accordance with a surrounding communication environment, a communication system with a higher priority to select antennas is set to the wireless LAN and both operation states of the communication by the wireless LAN and by the bluetooth are brought into on-states, will be described.

In the case, the switch 23 does not vary the connection relations among the antennas 21, 22, the LAN RF unit 24 and the bluetooth RF unit 26 even is the surrounding communication environment has changed.

As mentioned above, the notebook PC according to the first embodiment of the present invention firstly selects an antenna to use communication by the wireless LAN being a communication system with a higher priority among a plurality of antennas if both operation states of communication functions by the wireless LAN and the bluetooth are on-state.

This notebook PC sets an antenna not used as an antenna for the wireless LAN to an antenna for the bluetooth to be a communication system with a lower priority regardless of surrounding communication environment. Therefore, this notebook PC can perform communication combining each communication system after employing a shred antenna corresponding to a plurality of communication systems.

In the example described above, the notebook PC sets the wireless LAN as a communication system with a higher priority of an antenna selection coming along with a user's selection of the LAN icon 43 on the setting screen G1 (cf. FIG. 4).

However, not being limited to this example, the switch 23 can switch antennas in accordance with the surrounding communication environment; the notebook PC may display an icon of other communication system onto the setting screen G1 if the other systems are supported by the notebook PC.

In this case, when the user selects the displayed icon, the notebook PC sets the communication system corresponding to the selected icon as the communication system with the higher priority of the antenna selection.

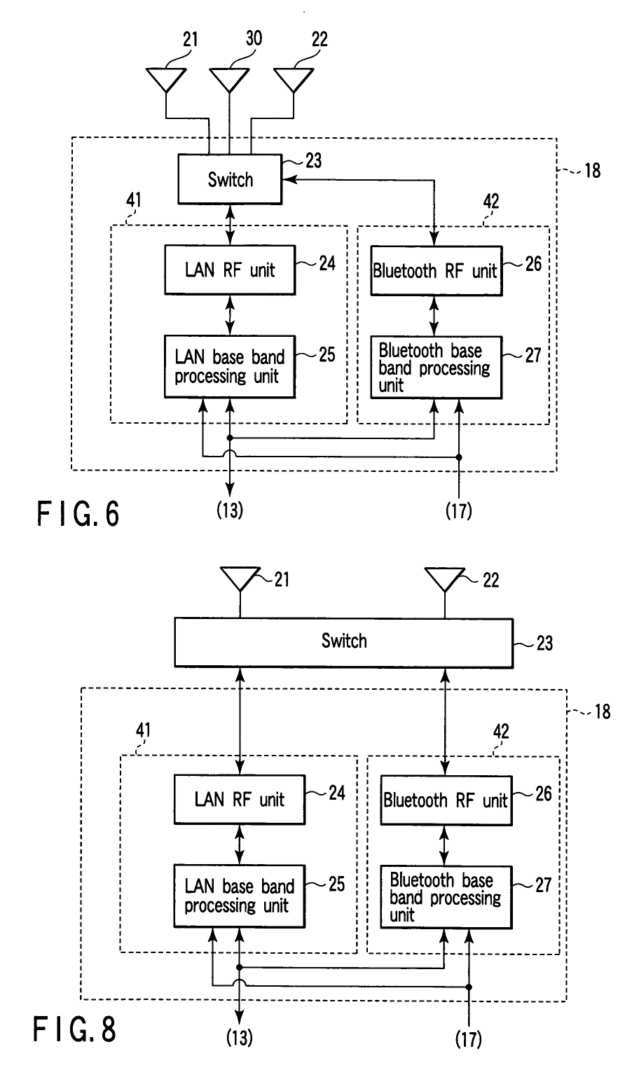

Next, a first modified example of the first example of the present invention will be described. FIG. 6 is a block diagram showing a configuration example of the inner circuit of the radio communication module 18 of the notebook PC according to the first modified example of the first embodiment of the invention.

Each notebook PC shown in FIG. 2 and FIG. 3 has two antennas connected to the switch 23. This notebook PC connects either of two antennas to the LAN RF unit 24 by the switch 23 in the case of communication by the wireless LAN.

However, in this first modified example, as shown, for example, in FIG. 6, the switch 23 is connected to three antennas. These three antennas mean the antennas 21, 22 and 30. The switch 23 of the notebook PC according to the first modified example connects any one of these three antennas to the LAN RF unit 24 when the communication by the wireless LAN is performed.

Operations of the switch 23 in the case that the notebook PC according to the first modified example performs both communications by the wireless LAN and the bluetooth will be explained.

In this case, the switch 23 connects any one antenna not connected to the LAN RF unit 24 among these three antennas to the bluetooth RF unit 26. The number of antennas connected to the switch 23 may be the number over three.

Next, a second modified example of the first embodiment of the present invention will be described.

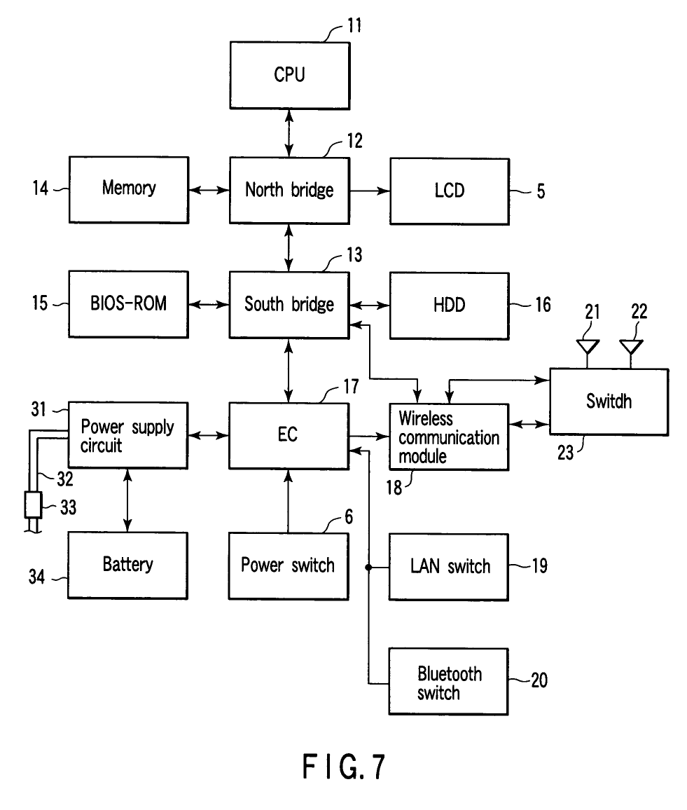

FIG. 7 is a block diagram showing a configuration example of an inner circuit of the notebook PC according to the second modified example of the first embodiment. FIG. 8 is a block diagram showing a configuration example of an inner circuit of the module 18 according to the second modified example of the first embodiment.

In the configuration shown in FIG. 3, the switch 23 is incorporated in the module 18. However, in the second modified examples, as shown in FIG. 7 and FIG. 8, the switch 23 is a device different from the module 18.

In the second modified example, the switch 23 and the LAN RF unit 24 of the module 18 are connected with each other, and the switch 23 is connected to the bluetooth RF unit 26 of the module 18.

Next, a third modified example of the first embodiment of the present invention will be described.

In the processing according to the flowchart shown in FIG. 5, the notebook PC according to the first embodiment of the present invention firstly selects both antennas connected to the LAN RF unit 24 and the bluetooth RF unit 26.

The notebook PC performs processing to vary antennas connected to the LAN RF unit 24 and the bluetooth RF unit 26, respectively, in accordance with the surrounding communication environment.

The notebook PC according to the first modified example performs this processing regardless of whether or not during transmissions and receptions of signals by the wireless LAN or by the bluetooth.

However, if the notebook PC performs processing to select an antenna during the transmission and reception, the communication is interrupted in temporary and communication efficiency is deteriorated. In contrast, the notebook PC according to the third modified example performs processing to select an antenna without interrupting the communication.

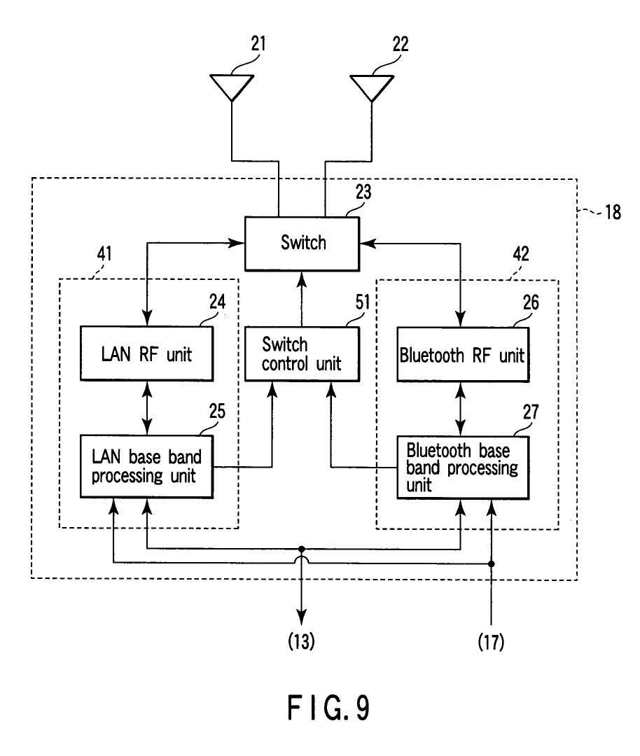

FIG. 9 is a block diagram showing a configuration of an inner circuit of the module 18 of the notebook PC according to the third modified example of the first embodiment of the present invention.

As shown in FIG. 9, the module 18 of the notebook PC according to the third modified example of the first embodiment further comprises a switch control unit 51 compared to the configuration shown in FIG. 3. The switch control unit 51 is connected to the switch 23, the LAN baseband processing unit 25 and the bluetooth baseband processing unit 27.

In this third modified example, when not performing a transmission and a reception of a signal by the wireless LAN, the LAN baseband processing unit

outputs a control signal indicating the fact of no transmission and reception of the signal by the wireless LAN to the switch control unit 51. When not performing a transmission and a reception of a signal by the bluetooth, the bluetooth baseband processing unit 27 outputs a control signal indicating the fact of no transmission and reception of the signal by the bluetooth to the switch control unit 51.

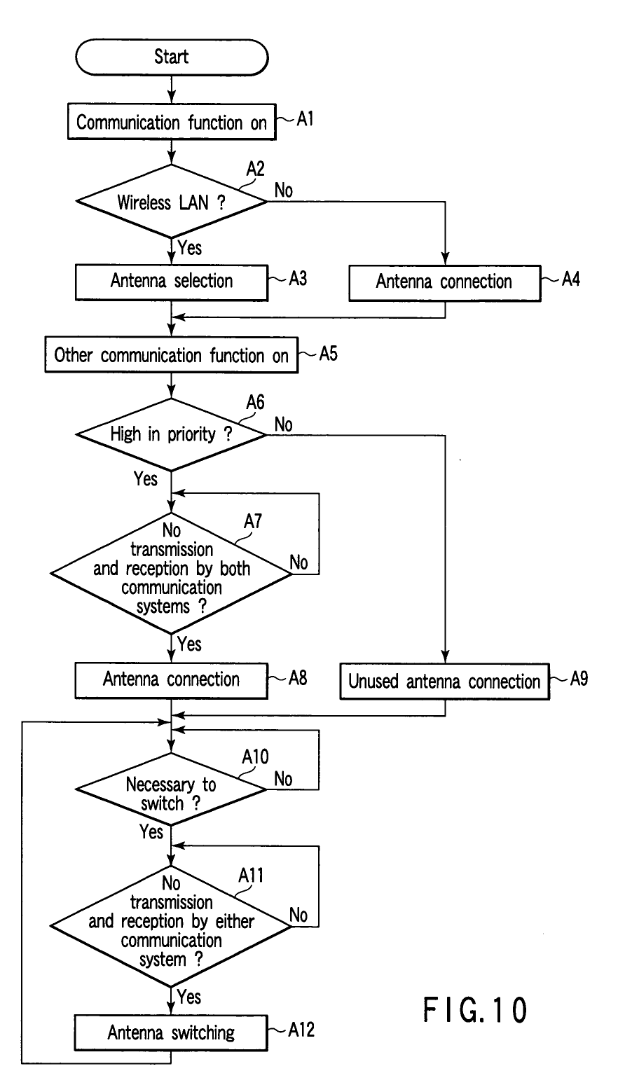

FIG. 10 is a flowchart showing a content of communication control processing executed by the notebook PC according to the third modified example of the first embodiment of the present invention.

The notebook PC according to this modified example performs the same processing as that of the foregoing Steps S1 to S6 (steps A1-A6).

Operations of the switch control unit 51 in the case of discrimination of “YES” in the processing of step A6 and no transmission and reception by both communication systems (YES, in step S7) will be explained.

The case of no transmission and reception by both communication systems means the case that the switch control unit 51 inputs a control signal indicating the fact of no transmission and reception from the LAN baseband processing unit 25 by the wireless LAN and no transmission and reception from the bluetooth baseband processing unit 27 by the bluetooth.

In this case, the switch control unit 51 assumes that both transmissions and receptions of signals by the wireless LAN and the bluetooth and outputs a permission signal for an antenna selection to the switch 23.

The switch 23 inputs the control signal to instruct the selection of an antenna connected to the LAN RF unit 24 from the antennas 21 and 22 in accordance with the surrounding communication environment from the LAN baseband processing unit 25.

When inputting the permission signal from the switch control unit 51 in this state, the switch 23 connects either antenna 21 or 22 to the LAN RF unit 24 in accordance the control signal for the antenna selection input from the LAN baseband processing unit 25 (step A8).

Then, an antenna to be connected to the bluetooth RF unit 26 becomes an antenna not connected to the LAN RF unit 24.

In contrast, in the case of discrimination of “NO” by the processing in the step A6, the same processing as that of the step S8 is performed (step A9). After the processing in the step A8 or A9, the same step as that of the step S9 is performed (step A10).

If the processing in the step A10 discriminates “YES”, namely, if the switch 23 inputs a control signal for instructing switching of an antenna connected to the LAN RF unit 24 in accordance with the surrounding communication environment, the notebook PC executes the same processing as that of in the step A7 (step All).

Operations of the switch 23, in the case of discrimination of “YES” by the processing in the step All, namely, in the case of inputting of the permission signal from the switch control unit 51, will be explained below.

In this case, the switch 23 connects either the antenna 21 or 22 to the LAN RF unit 24 in accordance with the control signal to select antennas from the LAN baseband processing unit 25 (step A12).

Then, the antenna to be connected to the bluetooth RF unit 26 becomes one which has not been connected to the LAN RF unit 24.

As stated above, the notebook PC according to the third modified example of the first embodiment of the present invention can perform the processing to select the antenna to be used for communication without breaks of transmissions and receptions of signals.

The notebook PC according to this modified example selects the antenna in both cases of no communication by the wireless LAN and by the bluetooth.

However, it is not limited to this modified example, if the communication system with the higher priority of the antenna selection is the wireless LAN, the notebook PC according to this modified example may select the antenna regardless of execution of the communication of bluetooth being other communication system, if the communication by the wireless LAN is not performed.

### SECOND EMBODIMENT

Next, a second embodiment of the present invention will be described. The configuration of the appearance of the notebook PC according to this embodiment is basically and approximately same as that shown in FIG. 1, so that a drawing and an explanation thereof will be eliminated.

In the above-mentioned examples, the modules 18 have functions to perform the communication by two kinds of communication systems, which are the wireless LAN and the bluetooth.

However, in this second embodiment, the module 18 has a communication function by a third radio communication system in addition to the communication functions by the wireless LAN and the bluetooth.

The third radio communication system is a communication system using electric waves of a 2.4 GHz band to be a frequency band corresponding to the wireless LAN and the bluetooth. Hereinafter, the third radio communication system is referred to as a standard X.

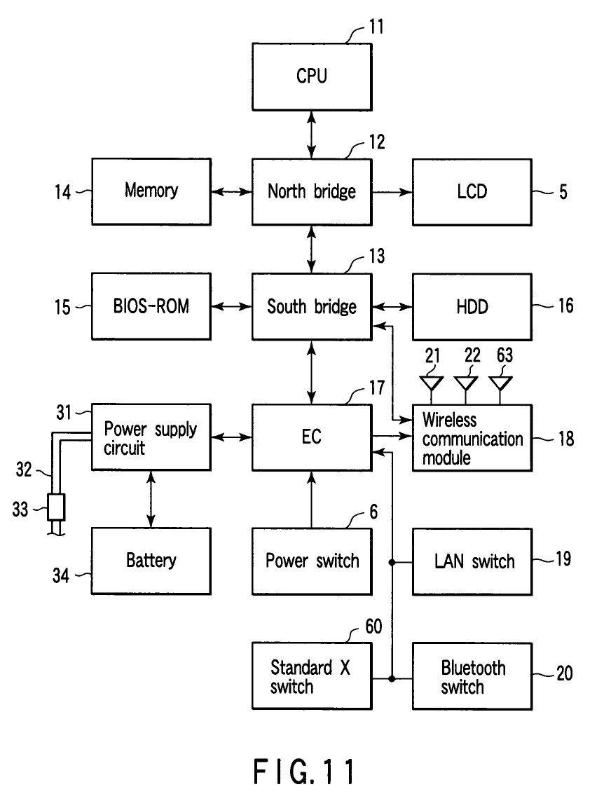

FIG. 11 is a block diagram showing a configuration example of an inner circuit of the notebook PC according to the second embodiment of the present invention.

As shown in FIG. 11, the notebook PC according to the second example of the present invention further comprises a switch for a standard X (hereinafter referred to as standard X switch) 60 compared to the configuration of the inner circuit, shown in FIG. 2, of the notebook PC according to the first embodiment of the present invention. The standard X switch 60 accepts an operation to switch operation states of the communication function by the standard X. The standard X switch 60 is connected to the EC 17.

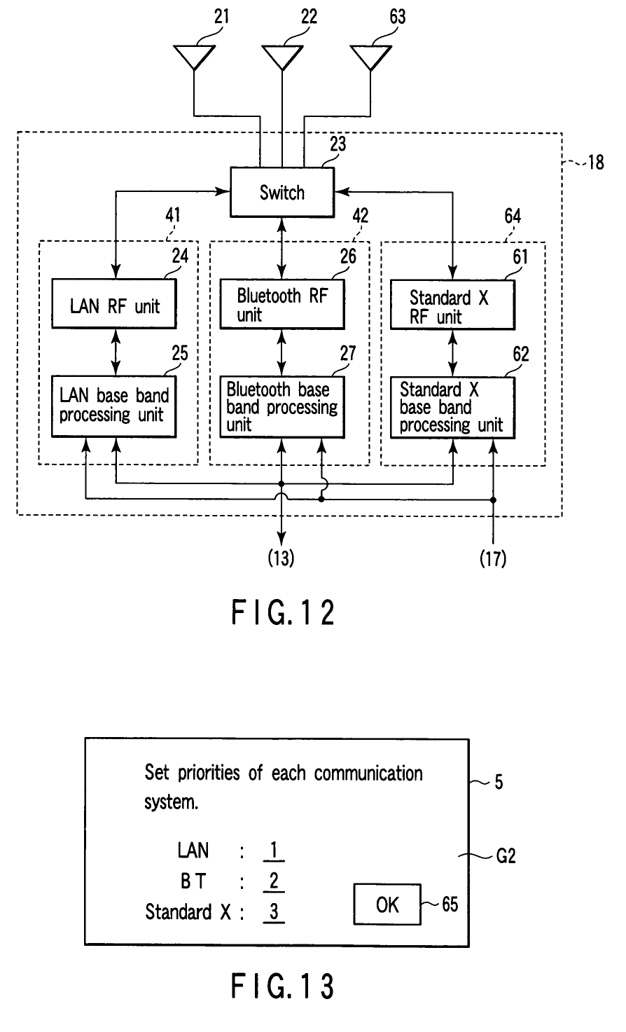

FIG. 12 is a block diagram showing a configuration of an inner circuit of the module 18 of the notebook PC according to the second embodiment of the present invention.

AS shown in FIG. 12, in the notebook PC according to the second embodiment of the present invention, the switch 23 is also connected to an antenna 63 compared to the configuration in FIG. 3. The module 18 further comprises a standard X communication circuit 64 compared to the configuration shown in FIG. 3. The communication circuit 64 includes an RF unit for standard X (hereinafter referred to as standard X RF unit) 61 and a baseband processing unit for standard X (hereinafter referred to as standard X baseband processing unit) 62.

The standard X RF unit 61 and the standard X baseband processing unit 62 are devices having functions to perform communication by the standard X. An antenna 63 is the same antenna as the antennas 21 and 22. The standard X RF unit 61 is connected to the baseband processing unit 62. The standard X baseband processing unit 62 is connected to the EC 17 and the SB 13.

When detecting the depressing of the standard X switch 60 by the user, the EC 17 discriminates an operation state of the standard X communication circuit 64, namely, an operation state of a communication function by the standard X to shift the operation state of the standard X communication circuit 64 between an on-state and an off-state.

The switch 23 varies the connection relations among the antenna 21 and a variety of RF units so that a high-frequency signal from the antenna 21 is output to any one of the LAN RF unit 24, the bluetooth RF unit 26 and the standard X RF unit 61.

The variety of RF units mean the LAN RF unit 24, the bluetooth RF unit 26 and the standard X RF unit 61.

The switch 23 varies the connection relations among the antenna 22 and the variety of RF units so that high-frequency signals from the antenna 22 are output to any one of the variety of RF units.

The switch 23 varies the connection relations among the antenna 63 and the variety of RF units so that high-frequency signals from the antenna 63 are output to any one of the variety of RF units. However, the switch 23 varies the connection relations among the antennas 21, 22, 63 and the variety of RF units so that two or more kinds of signals among high-frequency signals from the antennas 21, 22 and 63 are not collectively output to more than one of the variety of RF units.

The switch 23 outputs a signal input from the LAN RF unit 24 to any one of the antennas 21, 22 and 63. The switch 23 outputs a signal input from the bluetooth RF unit 26 to any one of the antennas 21, 22 and 63. The standard X RF unit 61 downconverts the high-frequency signal output from the switch 23 into a baseband signal. The standard X RF unit 61 converts the baseband signal output from the standard X baseband processing unit 62 into a high-frequency signal. The standard X baseband processing unit 62 converts the baseband signal, which is output from the standard X RF unit 61, into a digital signal possible to be processed by the CPU 11 of the notebook PC.

The standard X baseband processing unit 62 outputs this converted digital signal to the SB 13. The standard X baseband processing unit 62 D/A-converts digital data sent from the SB 13 into an analog signal to output it to the standard X RF unit 61.

The user similarly sets the priority of the antenna selection as mentioned above even by the notebook PC according to the second embodiment. However, three kinds of communication systems are utilized herein.

Thereby, the notebook PC according to the second embodiment sets the communication systems not in accordance with the level of the priorities but in accordance with the first, second and third priorities, respectively.

Next, communication control processing by the notebook PC according to the second embodiment of the present invention will be explained.

FIG. 13 is a view showing an example of a setting screen G2 regarding the communication control processing by the notebook PC according to the second embodiment of the present invention.

The setting screen shown in FIG. 13 is a screen to set the communication systems respectively corresponding to the first, second and third priorities at the time of performing of communication by the module 18.

The user performs prescribed operations to the keyboard 4, then, the LCD 5 displays the setting screen G2 (cf. FIG. 13).

Operations of the SB 13, after the user inputs numeric figures indicating priorities of the antenna selections of each communication system, respectively, in accordance with this screen G2 and in the case of a selection of an OK icon 65 on the screen G2, will be described as follows.

In this case, the SB 13 outputs the information denoting the communication systems respectively having the first, second and third priorities of the antenna selections to the BIOS-ROM 15. This information is stored in the BIOS-ROM 15.

When setting numeric figures indicating priorities, respectively, the user operates the keyboard 4 to input “1” to an item of a communication system having the highest (first) priority, input “2” to an item of the communication system having the second priority and input “3” to an item of the communication system having the lowest (third) priority, respectively.

Operations of the notebook PC, according to the second modified example if the first embodiment of the present invention when all operation states of the communication functions by three kinds of communication systems including the wireless LAN are on-states, will be described below.

In such a case, the notebook PC according to the above-mentioned second modified example switches an antenna used for the wireless LAN prior to antenna selections for communication by other communication systems in response to a surrounding communication environment.

The notebook PC according to the third modified example selects one antenna by this selection, among the remaining two antennas which have not been used for communication by the wireless LAN, as an antenna for the bluetooth prior to an antenna selection for the standard X.

Then the notebook PC uses the remaining one antenna, which has not been used for the communication by the wireless LAN and the bluetooth, as an antenna for the standard X.

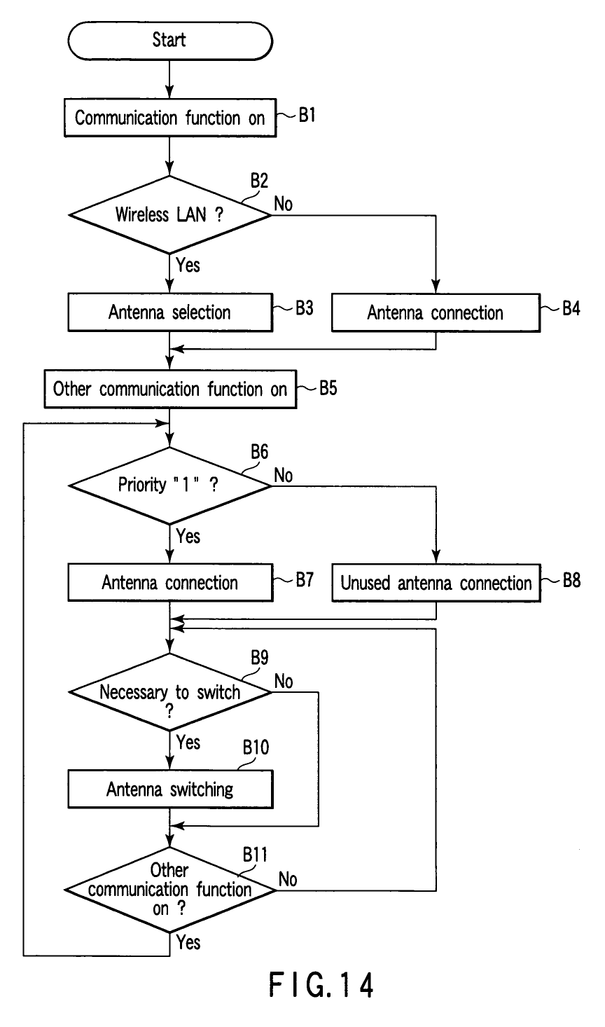

FIG. 14 is a flowchart showing a content of communication control processing executed by the notebook PC according to the second embodiment of the present invention.

Here, as shown in FIG. 13, it is assumed that the wireless LAN is set as a communication system having the first priority of an antenna selection. It is assumed that the bluetooth is set as a communication system having the second priority of the antenna selection. It is assumed that the standard X is set as a communication system having the third priority of the antenna selection.

Here, the combination of the priorities set for each communication system may be another combination if the first priority is only set to a communication system corresponding to a function to switch antennas according to a surrounding communication environment.

The notebook PC according to the second embodiment of the present invention performs the same processing as that of the foregoing Steps S1 to S6 (steps B1-B6).

However, an antenna to be connected to the LAN RF unit 24, the bluetooth RF unit 26 and the standard X RF unit 61, respectively, is any one of the antennas 21, 22 and 63.

Operations of the SB 13, in the case that the communication system of which the operation state becomes an on-state by the processing in step B1 is the standard X, will be described.

In this case, the SB 13 outputs a control signal, including information about the kind of an antenna connected to the standard X RF unit 61 among the antennas 21, 22 and 63, to the switch 23 of the module 18, as the processing in the step B4.

When inputting a control signal from the SB 13, the switch 23 connects one antenna denoted by the information included in the control signal from the SB 13 among the antennas 21, 22 and 63 to the standard X RF unit 61.

After this processing, the SB 13 reads out the information of the priority set to the communication system, the operation state of which is turned to the on-state by the processing in the step B1 from the memory 14. The SB 13 associates the read out information with the information indicating the kind of the antenna connected as mentioned above to store it in the memory 14.

Then, operations in the case of discrimination of “YES” by the processing in the step B6 after the processing in the step B5 will be described. The case of discrimination of “YES” by the processing in the step B6 is one that the priority, which is set by the communication system of the communication function in which the operation state is newly shifted to an on-state by the processing in the step B5, is “1”.

In the present case, the SB 13 outputs a control signal indicating a device used for the communication by the communication system of the communication function in which the operation state is newly shifted to the on-state among a variety of RF units as described above to be connected to any one of the antennas 21, 22 and 63 to the switch 23 via the LAN communication circuit 41.

The switch 23 inputs the control signal from the SB 13. Then, the switch 23 connects a device to perform communication by the communication system of the communication function in which the operation state is newly shifted by the processing in the step B5 among a variety of RF units to the antenna decided in accordance with the surrounding communication environment among the antennas 21, 22 and 63 (step B7).

In contrast, operations of the SB 13, in the case of discrimination of “NO” by the processing in the step B6, namely, the case that the priority which is set in the communication system of the communication function in which the operation state is newly shifted to the on-state is not “1”, will be explained. In such a case, the SB 13 outputs a control signal including the information indicating one kind of an antenna other than the antennas connected to any of the variety of RF units to the switch 23 via the LAN communication circuit 41.

When inputting the control signal from the SB 13, the switch 23 connects a device to perform communication by the communication system of the communication function in which the operation state is shifted to the on-state by the processing in the step B5 among the variety of RF units to the antenna of the kind indicated by the information included in this control signal (step B8).

However, if the information of the communication system to which a priority having a priority lower than that which is set in the information of the communication system of the communication function in which the operation state is newly shifted to the on-state has already included, as the information of the communication system of the communication function in which the operation state has already been shifted to the on-state, to the information stored in the memory 14, the switch 23 may set the following antennas as connection targets by the processing in the step B7.

The antennas to be connected are those that have already been connected to any one of the variety of RF units to perform communication by the communication system of the communication function, the operation state of which is newly shifted to the on-state.

An operation of the switch 23, in the case that the antenna already connected to any device of the variety of RF units becomes an antenna to be connected by the processing in the step B7 or B8, will be described.

In the present case, the switch 23 switches the antenna connected to the foregoing device to an antenna not connected to none of the variety of RF units.

Operations of the LAN baseband processing unit 25, in the case of antenna switching by the diversity function of the wireless LAN after the processing in the step B7 or B8 (YES, in step B9), will be described.

The case of the need of antenna switching by the diversity function is one that the magnitude correlation between the signal-to-noise ratio of a high-frequency signal from the antenna 21 and the signal-to-noise ratio of a high-frequency signal from the antenna 22 is varied as the result from the comparison of the signal-to-noise ratios of the high-frequency signals by the LAN baseband processing unit 25.

In such a case, the LAN baseband processing unit 25 outputs a control signal for instructing a selection of an antenna to be connected to the LAN RF unit 24 among the antennas 21, 22 and 63 to the switch 23. The switch 23 inputs the control signal from the LAN baseband processing unit 25 to select an antenna to be connected to the LAN RF unit 24 (step B10).

As the result from the processing in the step B10, the antenna connected to the bluetooth RF unit 26 and the antenna connected to the standard X RF unit 61 become the antennas different form that newly connected to the LAN RF unit 24 by the processing in the step B10.

Operations of the EC 17, in the case of discrimination of “NO” after the processing in the step B10 or by the processing in the step B9, and also in the case that the user operates any one of the LAN switch 19, the bluetooth switch 20 and the standard X switch 60, then, the operation state of the communication function, the operation state of which is still an off-state is shifted to an on-state, will be explained below.

In this case, the EC 17 discriminates that which is the switch operated by the user among the LAN switch 19, the bluetooth switch 20 and the standard X switch 60.

The SB 13 checks the information on the priorities of the antenna selections in each communication system, wherein the information is related to the kinds of switches discriminated by the EC 17 and the information stored in the BIOS-ROM 15.

With such checking, the SB 13 discriminates whether or not the priority which is set by the communication system of the communication function, the operation state of which is newly shifted to an on-state by the processing in the step B11 is higher than that which is set by the communication system of the communication function, the operation state of which is shifted to the on-state before the processing in the step B11 (step B11 to B6).

After this, the notebook PC performs again the processing in the step B7-B10, namely, the same processing as those in the steps S7-S10. The notebook PC performs again the processing in the step B9 and B10, namely, the same processing as those in the steps S9 and S10 when the processing in the step B11 discriminates “NO”.

As mentioned above, the notebook PC according to the second embodiment of the present invention can collectively perform communication by each communication system even when a shared antenna corresponding to the communication systems of two or more kinds is used.

The notebook PC according to this second embodiment uses three antennas to be connected to the switch 23. However, the number of antennas is not limited to three; the number more than three is acceptable, if the number is not less than that of the kinds of the communication systems which can be executed by the module 18.

The module 18 may be structured to respectively perform communication by the communication systems of 4 or more kinds. In this case, the number of antennas connected to the switch 23 may be set to the number of the kinds of the communication systems which can be executed by the module 18.

### THIRD EMBODIMENT

Next, a third embodiment will be explained. The configuration of the appearance of the notebook PC regarding this embodiment is basically and approximately the same as that shown in FIG. 1, so that a drawing and an explanation thereof will be eliminated.

The notebook PC according to the first embodiment of the present invention mounts a circuit to perform communication by the wireless LAN and a circuit to perform communication by the bluetooth on the identical substrate.

In contrast, the notebook PC according to the third embodiment of the present invention mounts these circuits on different substrates, respectively.

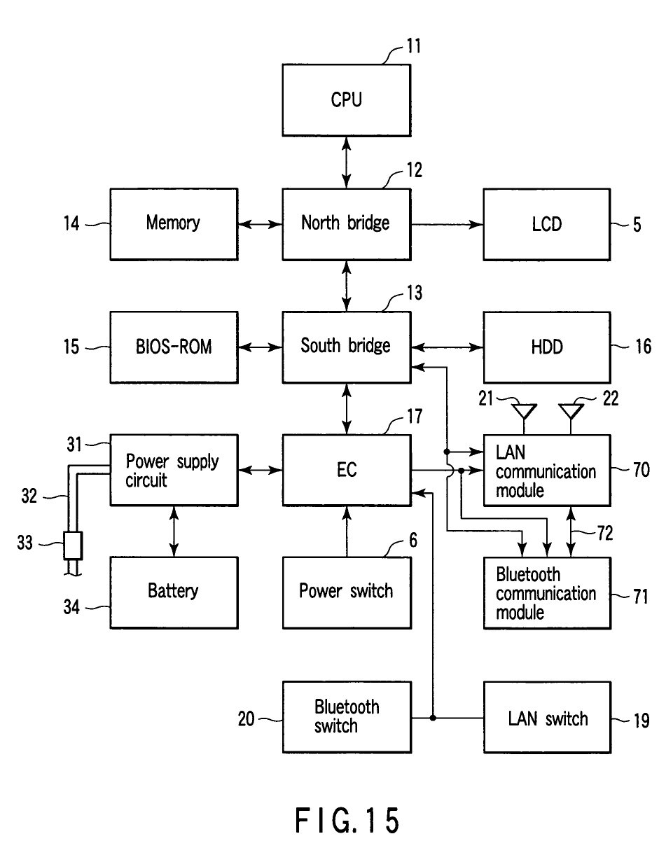

FIG. 15 is a block diagram showing a configuration example of an inner circuit of the notebook PC according to the third embodiment of the present invention.

As shown in FIG. 15, the notebook PC according to the third embodiment has a LAN communication module 70 and a bluetooth communication module 71 in stead of the radio communication module 18 compared to the configuration of the inner circuit of the notebook PC according to the first embodiment of the present invention (cf. FIG. 2).

The module 70 is connected to the module 71 via a relay cable 72. The modules 70 and 71 are connected to both SB 13 and EC 17.

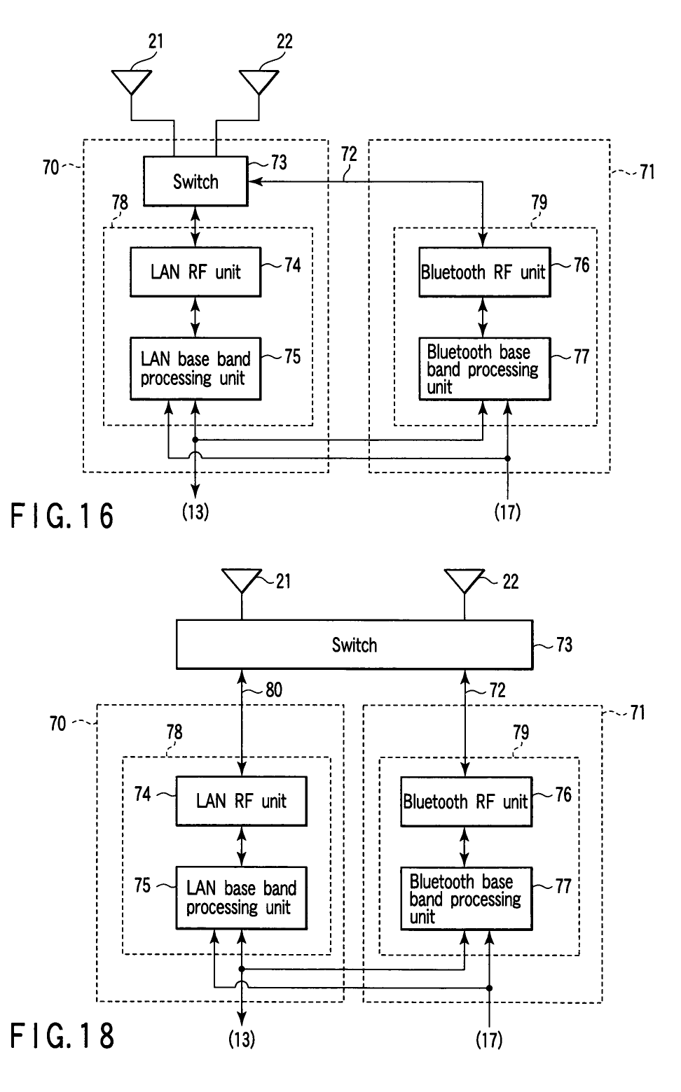

FIG. 16 is a block diagram showing a configuration example of inner circuits of the modules 70 and 71.

As shown in FIG. 16, the module 70 has the same switch 73 as the switch 23 (cf. FIG. 3) and a LAN communication circuit 78. The LAN communication circuit 78 has a LAN RF unit 74 and a LAN baseband processing unit 75. The LAN RF unit 74 is the same device as the LAN RF unit 24 (cf. FIG. 3).

The LAN baseband processing unit 75 is the same device as the LAN baseband processing unit 25 (cf. FIG. 3). The switch 73 is connected to the antennas 21 and 22. The switch 73 is connected to the EC 17 and the SB 13 through the LAN RF unit 74 and the LAN baseband processing unit 75.

The module 71 has a bluetooth communication circuit 79. The bluetooth communication circuit 79 has a bluetooth RF unit 76 and a bluetooth baseband processing unit 77. The bluetooth RF unit 76 is the same device as the bluetooth RF unit 26 (cf. FIG. 3).

The bluetooth baseband processing unit 77 is the same device as the bluetooth baseband processing unit 27 (cf. FIG. 3).

The bluetooth RF unit 76 is connected to the switch 73 of the module 70 via the relay cable 72. The bluetooth RF unit 76 is connected to the EC 17 and the SB 13 through the bluetooth baseband processing unit 77.

The switch 73 varies connection relations among the antenna 21, the LAN RF unit 74 and the bluetooth RF unit 76 so that the high-frequency signal from the antenna 21 is output to either the LAN RF unit 74 or the bluetooth RF unit 76.

The switch 73 varies connection relations among the antenna 22, the LAN RF unit 74 and the bluetooth RF unit 76 so that the high-frequency signal from the antenna 22 is output to either the LAN RF unit 74 or the bluetooth RF unit 76.

However, the switch 73 varies the connection relations among the antennas 21, 22, the LAN RF unit 74 and the bluetooth RF unit 76 so that the high-frequency signals from the antennas 21 and 22 are not collectively output to the LAN RF unit 74 or the bluetooth RF unit 76.

The notebook PC according to the third embodiment of the present invention divides the module 18 of the notebook PC according to the first embodiment (cf. FIG. 2) into the modules 70 and 71 to connect them by the relay cable 72 with each other.

Therefore, the content of communication control processing executed by the notebook PC according to the third embodiment is the same as that executed by the notebook PC according to the first embodiment.

That is, the notebook PC according to the third embodiment can collectively perform communication by each communication system by using the shared antenna corresponding to a plurality of communication systems even when the circuit to perform communication by the wireless LAN and the circuit to perform communication by the bluetooth cannot be mounted on the identical substrate because of, for example, the restriction on a space.

In the configuration shown in FIG. 16, the switch 73 is mounted in the LAN communication module 70. However the configuration should not be limited to this embodiment, the switch 73 may be connected to the LAN RF unit 74 of the module 70 by a cable while the switch 73 is mounted in the bluetooth communication module 71.

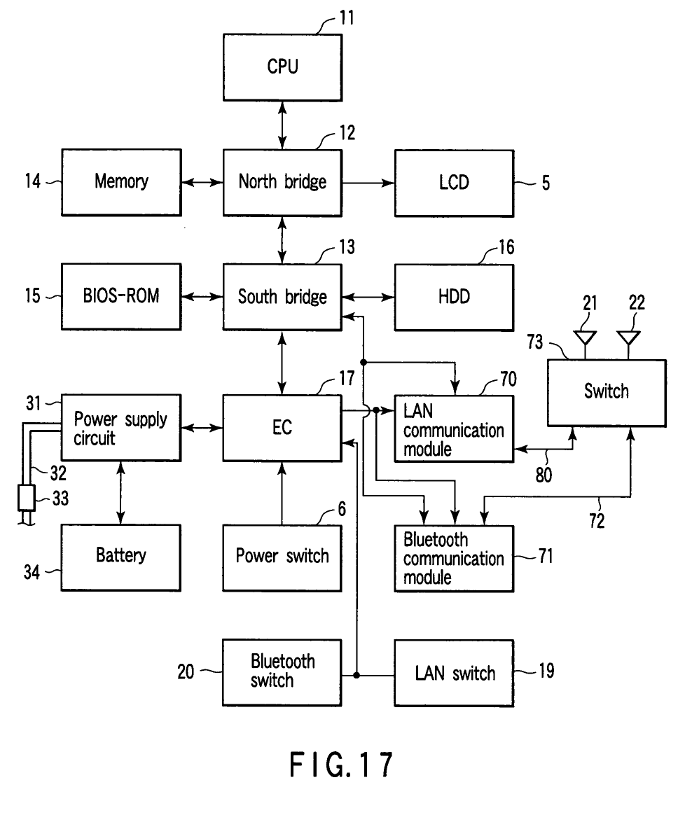

FIG. 17 is a block diagram showing other configuration example of the inner circuit of the notebook PC according to the third embodiment of the present invention. FIG. 18 is a block diagram showing other configuration example of the inner circuits of the modules 70 and 71 of the notebook PC according to the third embodiment of the present invention.

As shown in FIG. 17 and FIG. 18, other configuration examples of the inner circuits of the notebook PC according to the third embodiment do not mount the switches 73 in the modules 70, respectively.

This inner circuit is structured to connect the switch 73 to the LAN RF unit 74 of the module 70 through the relay cable 80 and connect the switch 73 to the bluetooth RF unit 76 of the module 71 through the relay cable 72.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus, comprising:
antennas;
a first radio communication unit which performs radio communication by a first communication system having an antenna switching function in response to a reception state of electronic waves when the first radio communication unit is connected to any one of the antennas;
a second radio communication unit which performs radio communication by a second communication system different from the first communication system when the second radio communication unit is connected to any one of the antennas;
a setting unit which sets priorities of connection to the antennas in the first and the second radio communication unit; and
a connection unit which connects any one of the antennas to a radio communication unit high in priority and connects the antennas not connected to the radio communication unit high in priority to a radio communication unit low in priority on the basis of the priorities which is set by the setting unit.

2. The electronic apparatus according to claim 1, wherein the first and the second radio communication units are mounted on a substrate.

3. The electronic apparatus according to claim 1, further comprising:
a discrimination unit which discriminates whether or not the first and the second radio communication units perform communication of a signal; wherein
the connection unit connects the radio communication unit high in priority to any one of the antennas when the setting unit sets to perform communication by both the first and the second radio communication systems and the discrimination unit discriminates that both the first and the second communication unit do not perform the communication of signals and connects the second radio communication unit to any one of antennas not connected to the radio communication unit high in priority among the antennas.

4. An electronic apparatus, comprising:
antennas:
a first radio communication unit which performs radio communication by a first communication system having an antenna switching function in response to a reception state of electronic waves when the first radio communication unit is connected to any one of the antennas;
a second radio communication unit which performs radio communication by a second communication system different from the first communication system when the second radio communication unit is connected to any one of the antennas;
a discrimination unit which determines which one of the antennas has a better wave-reception state than the other antennas, by comparing wave-reception states of the antennas; and
a connection unit which connects the first radio communication unit prior to the second radio communication unit to an antenna which is discriminated to be excellent in electric wave reception state by the discrimination unit among the antennas and connects the second radio communication unit to an antenna not connected to the first radio communication unit among the antennas, when it is set that communication is performed by both the first and the second communication system, respectively.

5. The electronic apparatus according to claim 4, wherein
the discrimination unit discriminates an antenna high in signal-to-noise ratio of a reception signal by comparing signal-to-noise ratios of signals from the respective antennas; and
the connection unit connects the first radio communication unit prior to the second radio communication unit when it is set that communication is performed by both the first and the second radio communication systems to an antenna which is discriminated high in signal-to-noise ratio by the discrimination unit among the antennas and connects the second radio communication unit to an antenna not connected to the first radio communication unit among the antennas.

6. The electronic apparatus according to claim 4, wherein
the discrimination unit discriminates an antenna low in error frequency of a reception signal by comparing error frequencies of signals form the respective antennas;
the connection unit connects the first radio communication unit prior to the second radio communication unit when it is set that communication is performed by both the first and the second radio communication systems to an antenna which is discriminated high in signal-to-noise ratio by the discrimination unit among the antennas and connects the second radio communication unit to an antenna not connected to the first radio communication unit among the antennas.

7. The electronic apparatus according to claim 4, wherein
the number of the antennas is three or more;
the number of the second radio communication unit is two or more and one or more less than the number of the antennas and the respective second radio communication unit perform communication by individual communication systems different from the first communication system;
the connection unit connects the first radio communication unit to any one of the antennas and connects the second radio communication unit corresponding to the communication system of the communication which is set that communication is performed to an antenna not connected to the first radio communication unit at one for one among the antennas when it is set that communication is collectively performed by three or more kinds of communication systems including the first communication system.

8. A communication control method for communication-controlling an electronic apparatus having antennas; a first radio communication unit which performs radio communication by a first communication system for performing radio communication having an antenna switching function in response to a reception state of electric waves when the first radio communication unit is connected to any one of the antennas; and a second radio communication unit which performs radio communication by a second communication system different from the first communication system when the second radio communication unit is connected to any one of the antennas, comprising:
discriminating an antenna in excellent reception state of electric waves by comparing the reception states of the electric waves by the respective antennas;
individually setting presence or absence of communication by the first and the second radio communication systems; and
connecting the first radio communication unit prior to the second radio communication unit to an antenna which is discriminated to be excellent in reception state of the electric waves among the antennas and connecting an antenna not connected to the first radio communication unit among the antennas to the second radio communication unit when it is set that communication is performed by both the first and the second radio communication systems.

9. The communication control method according to claim 8, further comprising:
discriminating an antenna high in signal-to-noise ratio of a reception signal by comparing signal-to-noise ratios of signals from the respective antennas; and
connecting the first radio communication unit prior to the second radio communication unit to an antenna discriminated high in signal-to-noise ratio of the signal among the antennas and connecting the second radio communication unit to an antenna not connected to the first radio communication unit among the antennas when it is set that communication is performed by both the first and the second radio communication systems.

10. The communication control method according to claim 8, further comprising:
discriminating an antenna low in error frequency of a reception signal by comparing error frequencies of signals from the respective antennas;
connecting the first radio communication unit prior to the second radio communication unit to an antenna which is discriminated to be low in error frequency of a reception signal among the antennas and connects the second radio communication unit to an antenna not connected to the first radio communication unit among the antennas when it is set that communication is performed by both the first and the second radio communication systems.

11. The communication control method according to claim 8, wherein
the number of the antennas is three or more;
the number of the second radio communication unit is two or more and one or more less than the number of the antennas and the respective second radio communication unit perform communication by individual communication systems different from the first communication system, further comprising:
having three or more antennas for the electronic apparatus;
having two or more and one or more less second radio communication unit for the electronic apparatus;
performing by individual communication systems different from the first communication system, respectively;
connecting the first radio communication unit to any one of the antennas among the antennas when it is set that communication is collectively performed by three or more kinds of communication systems including the first communication system and connecting the second radio communication unit corresponding to the set communication system of the communication to an antenna not connected to the first radio communication unit at one for one among the antennas.
